(19) United States
(12) Patent Application Publication
(10) Pub. No.: US 2026/0106167 A1
(43) Pub. Date: Apr. 16, 2026

(54) CURRENT COLLECTOR AND BATTERY

(71) Applicant: TOYOTA JIDOSHA KABUSHIKI KAISHA, Toyota-shi (JP)

(72) Inventors: Masayoshi HAGA, Nagoya-shi (JP); Masaki FURUKAWA, Toyota-shi (JP); Tetsuya MIMURA, Chiryu-shi (JP); Atsushi SUGIHARA, Toyota-shi (JP); Satoshi MORIYAMA, Nagoya-shi (JP); Keita YAMASHITA, Nagoya-shi (JP); Ryuto SAKAMOTO, Okazaki-shi (JP); Hideyuki NAGAI, Nagoya-shi (JP)

(73) Assignee: TOYOTA JIDOSHA KABUSHIKI KAISHA, Toyota-shi (JP)

(21) Appl. No.: 19/277,795

(22) Filed: Jul. 23, 2025

(30) Foreign Application Priority Data
Oct. 16, 2024 (JP) 2024-180980

(51) Int. Cl. H01M 4/66; H01M 50/533

(52) U.S. Cl. CPC H01M 4/667; H01M 50/533

(57) ABSTRACT

A current collector includes a support layer, an electrically conductive layer, and a tab portion. The support layer is composed of a resin composition having electric insulation. The electrically conductive layer is laminated on the support layer. The tab portion is constituted by a film-formed member. The tab portion includes a tab body portion and a heat release portion. The tab body portion is connected with the electrically conductive layer. The tab body portion is configured to be able to be joined to another electrically conductive member such that electric conduction with the other electrically conductive member is established. The heat release portion has been folded multiple times.

### CROSS-REFERENCE TO RELATED APPLICATION

This application claims priority to Japanese Patent Application No. 2024-180980 filed on Oct. 16, 2024. The disclosure of the above-identified application, including the specification, drawings, and claims, is incorporated by reference herein in its entirety.

### BACKGROUND

### 1. Technical Field

The present disclosure relates to a current collector and a battery.

### 2. Description of Related Art

Japanese Unexamined Patent Application Publication (Translation of PCT Application) No. 2024-510696 (JP 2024-510696 A) discloses a conventional polar plate. The polar plate includes a current collector, an active material layer, and an electric connection member. The current collector includes a support layer and an electrically conductive layer. The support layer is composed of an electrically insulating material. The electrically conductive layer is provided on one surface of the support layer. The electric connection member and the current collector are connected by welding, at an edge of the current collector. A region of the connection by welding is called a welding-junction region.

### SUMMARY

In a conventional current collector, the support layer is composed of an electrically insulating material. Therefore, the electric resistance of the current collector is relatively high. Thereby, at the time of energization, heat generation of the welding-junction region easily occurs.

The present disclosure has been made in view of the above problem, and has an object to provide a current collector that makes it possible to restrain local heat generation, and a battery that includes the current collector.

A current collector according to an aspect of the present disclosure includes a support layer, an electrically conductive layer, and a tab portion. The support layer is composed of a resin composition having electric insulation. The electrically conductive layer is laminated on the support layer. The tab portion is constituted by a film-formed member. The tab portion includes a tab body portion and a heat release portion. The tab body portion is connected with the electrically conductive layer. The tab body portion is configured to be able to be joined to another electrically conductive member such that electric conduction with the other electrically conductive member is established. The heat release portion has been folded multiple times.

A battery according to an aspect of the present disclosure includes an electrode body and an external terminal. The electrode body includes a first electrode, a second electrode, and a separator. The first electrode includes a current collector and an active material layer. The current collector includes a support layer, an electrically conductive layer, and a tab portion. The support layer is composed of a resin composition having electric insulation. The electrically conductive layer is laminated on the support layer. The tab portion is constituted by a film-formed member. The tab portion includes a tab body portion and a heat release portion. The tab body portion is connected with the electrically conductive layer. The tab body portion is configured to be able to be joined to another electrically conductive member such that electric conduction with the other electrically conductive member is established. The heat release portion has been folded multiple times. The active material layer is laminated on the electrically conductive layer. The separator is laminated on the active material layer. The second electrode is laminated on the active material layer through the separator. The external terminal is electrically connected with the tab body portion.

With the present disclosure, it is possible to restrain local heat generation of the current collector.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view showing a battery according to Embodiment 1;

FIG. 2 is a sectional view of an electrode body as viewed in a direction of arrow line II-II in FIG. 1;

FIG. 3 is a developed view of a first electrode in Embodiment 1;

FIG. 4 is a diagram of a tab portion of the developed first electrode as viewed from one direction;

FIG. 5 is a partial sectional view of the first electrode as viewed in a direction of arrow line V-V in FIG. 3;

FIG. 6 is a partial sectional view of the first electrode as viewed in a direction of arrow line VI-VI in FIG. 3;

FIG. 7 is a developed view of a first electrode in Embodiment 2; and

FIG. 8 is a partial sectional view of the first electrode as viewed in a direction of arrow line VIII-VIII in FIG. 7.

### DETAILED DESCRIPTION OF EMBODIMENTS

Current collectors and batteries according to embodiments of the present disclosure will be described below with reference to the drawings. In the figures, identical or corresponding portions are denoted by identical reference characters, and descriptions thereof are not repeated.

### Embodiment 1

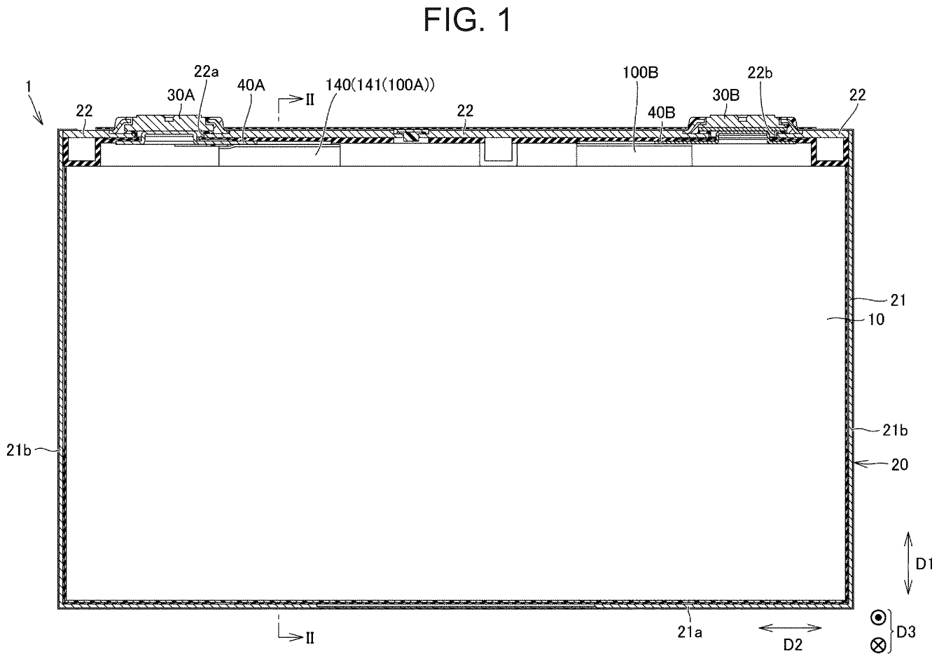

FIG. 1 is a sectional view showing a battery according to Embodiment 1. A battery 1 shown in FIG. 1 is a so-called rectangular battery. The battery 1 may be a secondary battery configured such that charging and discharging can be performed, as exemplified by a lithium-ion battery and a nickel-hydrogen battery. For example, the battery 1 can be used as a cell included in an electricity storage module that is mounted on an electrified vehicle.

As shown in FIG. 1, the battery 1 according to Embodiment 1 of the present disclosure includes an electrode body 10, a case 20, a first external terminal 30A, a second external terminal 30B, a first coupling member 40A, and a second coupling member 40B. First, constituents of the battery 1 other than the electrode body 10 will be described.

The case 20 has electric conductivity. A portion that is of the case 20 and that has electric conductivity is composed of a metal such as aluminum, for example. The case 20 houses the electrode body 10. The case 20 also houses an unillustrated electrolytic solution.

The case 20 includes a case body 21 and a lid 22. The case body 21 includes a bottom wall 21a and a peripheral wall 21b that stands from the bottom wall 21a.

The lid 22 is joined to the peripheral wall 21b by welding or the like, so as to close an opening of the peripheral wall 21b. On the lid 22, a first coupling hole 22a and a second coupling hole 22b are formed.

The first external terminal 30A and the second external terminal 30B are provided on the battery 1, so as to be exposed to the exterior. The first coupling member 40A and the second coupling member 40B have electric conductivity. At least a part of the first coupling member 40A and at least a part of the second coupling member 40B are disposed in the interior of the case 20.

The first external terminal 30A or the first coupling member 40A is inserted into the first coupling hole 22a. The first external terminal 30A is electrically connected with the first coupling member 40A. Specifically, the first external terminal 30A and the first coupling member 40A are joined to each other. The first coupling member 40A is joined to the electrode body 10. Thereby, the first external terminal 30A is electrically connected with the electrode body 10.

The second external terminal 30B or the second coupling member 40B is inserted into the second coupling hole 22b. The second external terminal 30B is electrically connected with the second coupling member 40B. Specifically, the second external terminal 30B and the second coupling member 40B are joined to each other. The second coupling member 40B is joined to the electrode body 10. Thereby, the second external terminal 30B is electrically connected with the electrode body 10.

In the embodiment, the first external terminal 30A is a positive electrode terminal, and the second external terminal 30B is a negative electrode terminal. The first external terminal 30A and the second external terminal 30B are arrayed in a second direction D2. The second direction D2 is a direction orthogonal to a first direction D1.

Next, the electrode body 10 will be described. The battery 1 according to the embodiment includes a plurality of electrode bodies 10. Typically, the battery 1 includes two electrode bodies 10. The electrode bodies 10 are arrayed in a third direction D3. The third direction D3 is a direction orthogonal to both of the first direction D1 and the second direction D2.

One electrode body 10 of the electrode bodies 10 will be described below. Each of the electrode bodies 10 may have the following configuration.

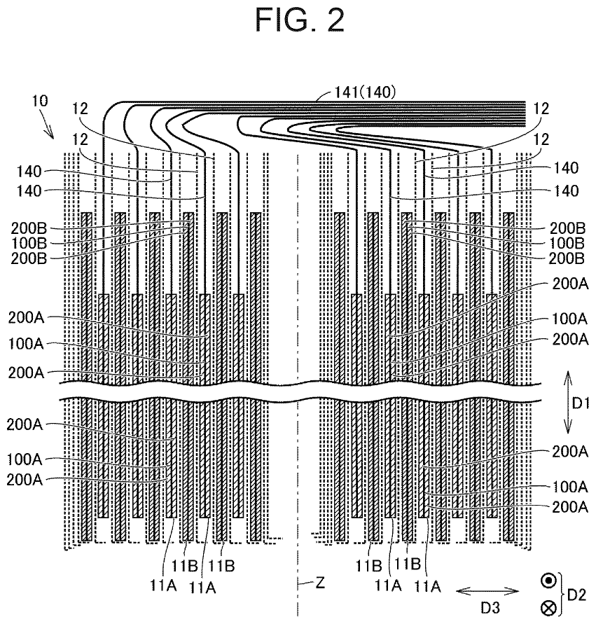

FIG. 2 is a sectional view of the electrode body as viewed in a direction of arrow line II-II in FIG. 1. As shown in FIG. 1 and FIG. 2, the electrode body 10 includes a first electrode 11A, a second electrode 11B, and a separator 12. In the electrode body 10, the first electrode 11A, the second electrode 11B, and the separator 12 are wound so as to surround the periphery of a winding axis line Z. In this way, in the embodiment, the electrode body 10 is a so-called wound electrode body. However, the electrode body 10 may be a laminated electrode body in which the first electrode 11A, the second electrode 11B, and the separator 12 are laminated in one direction (for example, the third direction D3). In FIG. 2, the separator 12 is schematically shown by broken lines.

Each external shape of the first electrode 11A and the second electrode 11B is a sheet shape. The electrode body 10 is constituted by a polar plate group in which the first electrode 11A and the second electrode 11B are wound through one or more separators 12. In the embodiment, the first electrode 11A is a positive electrode, and the second electrode 11B is a negative electrode. However, the first electrode 11A may be a negative electrode, and the second electrode 11B may be a positive electrode.

The separator 12 is provided between the first electrode 11A and the second electrode 11B. The separator 12 separates the first electrode 11A and the second electrode 11B, while allowing the movement of ions between the first electrode 11A and the second electrode 11B. The ions are lithium ions, for example. The separator 12 has electric insulation.

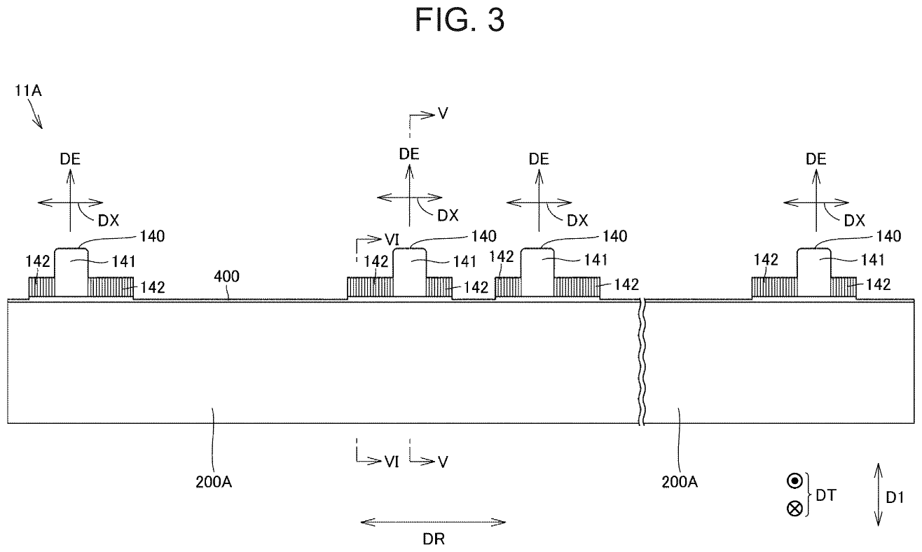

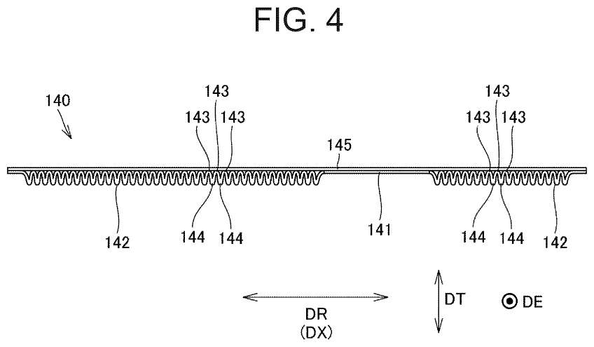

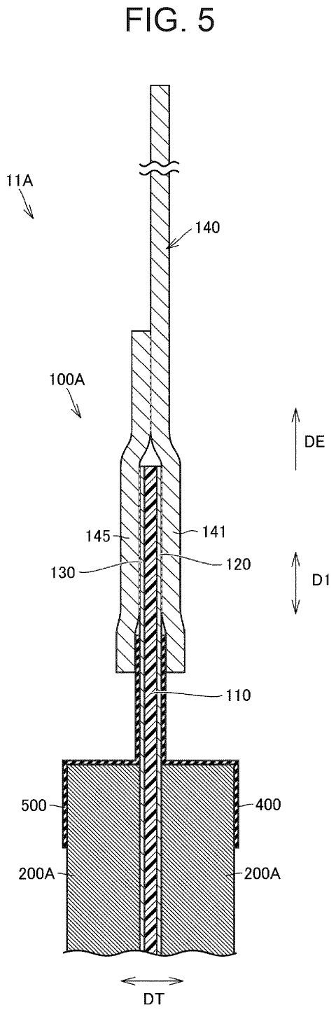

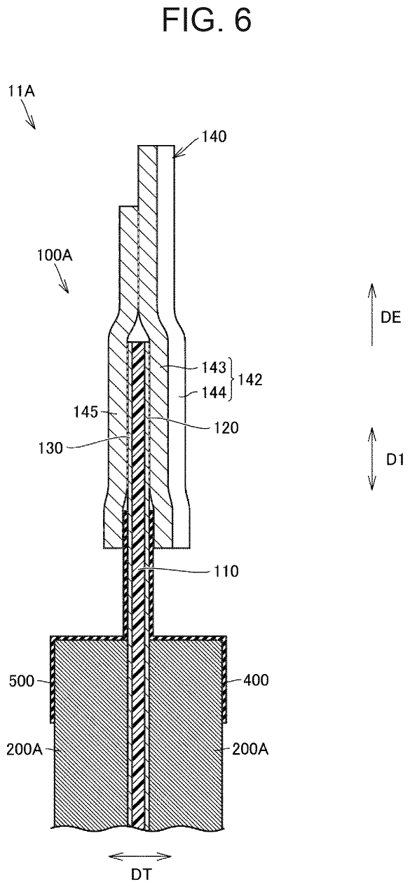

FIG. 3 is a developed view of the first electrode in Embodiment 1. That is, FIG. 3 shows a state before the first electrode 11A is wound. FIG. 4 is a diagram of a tab portion of the developed first electrode according to Embodiment 1 as viewed from one direction. FIG. 5 is a partial sectional view of the first electrode as viewed in a direction of arrow line V-V in FIG. 3. FIG. 6 is a partial sectional view of the first electrode as viewed in a direction of arrow line VI-VI in FIG. 3.

As shown in FIG. 2 to FIG. 6, the first electrode 11A includes a first current collector 100A, a first active material layer 200A, a first protection portion 400, and a second protection portion 500.

The first current collector 100A includes a support layer 110, a first electrically conductive layer 120, a second electrically conductive layer 130, and a plurality of tab portions 140.

The support layer 110 is composed of a resin composition having electric insulation. Therefore, the first current collector 100A is a composite current collector constituted by an electrically conductive member and an electrically insulating member. Thereby, the first current collector 100A is lighter and the safety of the whole of the battery 1 is higher, compared to a case where the whole of the first current collector 100A is composed of a metal.

The support layer 110 is composed of a resin composition containing polyamide resin, polyester resin, or polyolefin resin, for example. For high stiffness, it is preferable that the support layer 110 is composed of a resin composition containing polyester resin. It is further preferable that the support layer 110 is substantially composed of polyester resin. The polyester resin may be polyethylene terephthalate, for example. Thereby, it is possible to increase the stiffness of the first current collector 100A, while maintaining the electric insulation of the support layer 110. Furthermore, it is possible to relatively thin the support layer 110.

A thickness direction DT of the support layer 110 is roughly orthogonal to the first direction D1. That is, the support layer 110 extends in a direction roughly orthogonal to the first direction D1.

For reducing the whole thickness of the electrode body 10, the thickness of the support layer 110, for example, preferably should be 20 μm or less, more preferably should be 15 μm or less, and further preferably should be 10 μm or less. The thickness of the support layer 110 is not particularly limited as long as there is a desired stiffness. For example, the thickness of the support layer 110 may be 2 μm or more.

The first electrically conductive layer 120 is laminated on the support layer 110. The first electrically conductive layer 120 is provided on one surface of the support layer 110. The first electrically conductive layer 120 is provided over the whole of the one surface.

In the embodiment, the first electrically conductive layer 120 is positioned on the side of the winding axis line Z relative to the support layer 110. However, the first electrically conductive layer 120 may be positioned on the opposite side of the support layer 110 from the side of the winding axis line Z.

The second electrically conductive layer 130 is laminated on the support layer 110, so as to be opposed to the first electrically conductive layer 120. That is, the second electrically conductive layer 130 is provided on the other surface of the support layer 110. The second electrically conductive layer 130 is provided over the whole of the other surface.

The thickness of the first electrically conductive layer 120 and the thickness of the second electrically conductive layer 130 are smaller than the thickness of the support layer 110. For reducing the whole thickness of the electrode body 10, the thickness of the first electrically conductive layer 120 and the thickness of the second electrically conductive layer 130, for example, are 5 μm or less, more preferably should be 2 μm or less, and further preferably should be 1 μm or less. For restraining the electric resistance of the first electrically conductive layer 120 and the second electrically conductive layer 130 from being excessively high, the thickness of the first electrically conductive layer 120 and the thickness of the second electrically conductive layer 130 may be 0.1 μm or more, for example. In the case where the thickness of the first electrically conductive layer 120 and the thickness of the second electrically conductive layer 130 are 5 μm or less, it is difficult for the first electrically conductive layer 120 and the second electrically conductive layer 130 to be directly welded to each other or to be directly joined to each other by ultrasonic welding.

A method for forming the first electrically conductive layer 120 and the second electrically conductive layer 130 is not particularly limited. Typically, by a deposition method or the like, the first electrically conductive layer 120 and the second electrically conductive layer 130 may be provided on the support layer 110. Each of the first electrically conductive layer 120 and the second electrically conductive layer 130 may be constituted by a metal film. In this case, the first electrically conductive layer 120 and the second electrically conductive layer 130 may adhere to the support layer 110 through a resin adhesive.

Further, typically, each of the first electrically conductive layer 120 and the second electrically conductive layer 130 is composed of a metal containing aluminum. Thereby, the first current collector 100A including the first electrically conductive layer 120 and the second electrically conductive layer 130 can be suitably used as a positive electrode current collector. The first current collector 100A may be a negative electrode current collector, and each of the first electrically conductive layer 120 and the second electrically conductive layer 130 may be composed of a metal containing copper.

As shown in FIG. 3, the tab portions 140 are arrayed in a winding direction DR of the electrode body 10. The tab portions 140 are away from each other.

Moreover, as shown in FIG. 2, the tab portions 140 are arrayed in the third direction D3. The tab portions 140 are joined to each other by ultrasonic joining or the like. Furthermore, as shown in FIG. 1, the tab portions 140 are joined to the first coupling member 40A by ultrasonic joining or the like. Thereby, the first external terminal 30A is electrically connected with the tab portions 140. Constituents included in each of the tab portions 140 will be described below.

The tab portion 140 is constituted by one or more film-formed members. Typically, the tab portion 140 is constituted by a metal film containing aluminum or copper.

As shown in FIG. 3 to FIG. 6, the tab portion 140 includes a tab body portion 141, a plurality of heat release portions 142, and an assistance portion 145.

The tab body portion 141 is connected with the first electrically conductive layer 120. Typically, the tab body portion 141 is directly joined to the first electrically conductive layer 120. For example, the tab body portion 141 is joined to the first electrically conductive layer 120 by ultrasonic welding. The tab body portion 141 extends on the first electrically conductive layer 120 along the first direction D1. The tab body portion 141 extends so as to be away from the first electrically conductive layer 120. An extension direction DE of the tab body portion 141 is substantially parallel to the first direction D1.

The tab body portion 141 is configured to be able to be joined to another electrically conductive member such that electric conduction with the other electrically conductive member is established. In the embodiment, the tab body portion 141 is joined to the first coupling member 40A by ultrasonic joining. The tab body portion 141 may be directly joined to the first external terminal 30A.

As shown in FIG. 3, the heat release portion 142 is continuous with the tab body portion 141 in the winding direction DR. The heat release portion 142 is formed by a member that is integrated with the tab body portion 141. In the embodiment, two heat release portions 142 are respectively positioned on both sides of the tab body portion 141 in the winding direction DR. The heat release portion 142 is shorter than the tab body portion 141, in the extension direction DE of the tab body portion 141.

As shown in FIG. 6, the heat release portion 142 is positioned on the opposite side of the first electrically conductive layer 120 from the support layer 110. The heat release portion 142 is joined to the first electrically conductive layer 120 by ultrasonic welding.

As shown in FIG. 4, the heat release portion 142 has been folded multiple times. The tab body portion 141 has not been folded or has been folded a number of times smaller than the number of times of folding of the heat release portion 142. Typically, as shown in FIG. 2, the tab body portion 141 has been folded a number of times smaller than the number of times of folding of the heat release portion 142. Thereby, the tab body portion 141 and another electrically conductive member (the first coupling member 40A) are easily joined.

As shown in FIG. 4 and FIG. 6, the heat release portion 142 includes a plurality of valley fold portions 143 and a plurality of mountain fold portions 144.

The valley fold portions 143 and the mountain fold portions 144 are alternately arrayed. The valley fold portions 143 protrude to a first electrically conductive layer 120 side in the thickness direction DT. The mountain fold portions 144 protrude to a side opposite to the first electrically conductive layer 120 side in the thickness direction DT. The valley fold portions 143 extend along the extension direction DE. The valley fold portions 143 extend over the whole of the heat release portion 142. The mountain fold portions 144 extend along the extension direction DE. The mountain fold portions 144 extend over the whole of the heat release portion 142. The valley fold portions 143 are directly joined to the first electrically conductive layer 120 by ultrasonic joining.

The assistance portion 145 is joined to the second electrically conductive layer 130 by ultrasonic welding. The assistance portion 145 extends on the second electrically conductive layer 130 along the first direction D1. The assistance portion 145 extends from the second electrically conductive layer 130 in the extension direction DE. The assistance portion 145 is also joined to the tab body portion 141 and the heat release portion 142 (the valley hold portion 143) by ultrasonic welding. The assistance portion 145 is shorter than the tab body portion 141 and the heat release portion 142 (the valley fold portion 143) in the extension direction DE. Further, the assistance portion 145, the tab body portion 141, and the heat release portion 142 are arrayed in the thickness direction DT. Further, in the embodiment, the assistance portion 145 is formed by a metal film that is separate from the tab body portion 141 and the heat release portion 142.

Each thickness of the tab body portion 141, the heat release portion 142, and the assistance portion 145 is larger than the thickness of the first electrically conductive layer 120 and the thickness of the second electrically conductive layer 130. Each thickness of the tab body portion 141, the heat release portion 142, and the assistance portion 145, for example, preferably should be 20 μm or less, more preferably should be 15 μm or less, and further preferably should be 10 μm or less. Each thickness of the tab body portion 141, the heat release portion 142, and the assistance portion 145 is not particularly limited as long as there is a desired stiffness. For example, each thickness of the tab body portion 141, the heat release portion 142, and the assistance portion 145 may be 2 μm or more.

As shown in FIG. 2, FIG. 5, and FIG. 6, the first active material layer 200A is laminated on the first electrically conductive layer 120 and the second electrically conductive layer 130. The first active material layer 200A is a positive electrode active material layer, but may be a negative electrode active material layer. The first active material layer 200A is away from the tab portion 140.

The separator 12 is laminated on the first active material layer 200A in a radial direction from the winding axis line Z.

The first protection portion 400 is composed of a ceramic having electric insulation. As shown in FIG. 5 and FIG. 6, the first protection portion 400 covers a part that is of the first active material layer 200A laminated on the first electrically conductive layer 120 and that is on a side in the extension direction DE. The first protection portion 400 covers the whole of the surface of the first electrically conductive layer 120 between the first active material layer 200A and each of the tab body portion 141 and the heat release portion 142. The first protection portion 400 is partially disposed also between the first electrically conductive layer 120 and each of the tab body portion 141 and the heat release portion 142.

The second protection portion 500 is composed of a ceramic having electric insulation. The second protection portion 500 covers a part that is of the first active material layer 200A laminated on the second electrically conductive layer 130 and that is on a side in the extension direction DE. The second protection portion 500 covers the whole of the surface of the second electrically conductive layer 130 between the first active material layer 200A and the assistance portion 145. The second protection portion 500 is partially disposed also between the second electrically conductive layer 130 and the assistance portion 145.

As shown in FIG. 2, the second electrode 11B is laminated on the first active material layer 200A through the separator 12 in the above radial direction. In the embodiment, the electrode body 10 includes a plurality of separators 12, but may include a single separator 12.

The second electrode 11B includes a second current collector 100B and a second active material layer 200B. The second current collector 100B is pulled out from between second active material layers 200B to one side in the first direction D1. The second current collector 100B is joined to the second coupling member 40B by ultrasonic welding (see FIG. 1).

The second current collector 100B is constituted by a metal film, for example. The second current collector 100B is composed of a metal containing copper, for example. Thereby, the second current collector 100B can be suitably used as a negative electrode current collector. In the case where the first current collector 100A is a negative electrode current collector and the second current collector 100B is a positive electrode current collector, the second current collector 100B may be composed of a metal containing aluminum.

The second active material layer 200B is laminated on both surfaces of the second current collector 100B. In the embodiment, the second electrode 11B is a negative electrode. Therefore, the second active material layer 200B is a negative electrode active material layer. The second active material layer 200B may be a positive electrode active material layer.

As described above, the first current collector 100A according to Embodiment 1 includes the support layer 110, the first electrically conductive layer 120, and the tab portion 140. The support layer 110 is composed of a resin composition having electric insulation. The first electrically conductive layer 120 is laminated on the support layer 110. The tab portion 140 is constituted by a film-formed member. The tab portion 140 includes the tab body portion 141 and the heat release portion 142. The tab body portion 141 is connected with the first electrically conductive layer 120. The tab body portion 141 is configured to be able to be joined to another electrically conductive member such that electric conduction with the other electrically conductive member is established. The heat release portion 142 has been folded multiple times.

As described above, in the film-formed member constituting the tab portion 140, the heat release portion 142 has been folded multiple times, and thereby, it is possible to increase the surface area of the heat release portion 142 in a limited space (for example, in the interior of the case 20 of the battery 1). Thereby, it is possible to effectively release the heat generated at the connection portion between the first electrically conductive layer 120 and the tab body portion 141 at the time of energization. Consequently, it is possible to restrain local heat generation of the electrode body 10.

Further, in the embodiment, the tab body portion 141 extends so as to be away from the first electrically conductive layer 120. The heat release portion 142 includes the valley fold portions 143 and the mountain fold portions 144. The valley fold portions 143 and the mountain fold portions 144 are alternately arrayed. The valley fold portions 143 protrude to the first electrically conductive layer 120 side. The mountain fold portions 144 protrude to the side opposite to the first electrically conductive layer 120 side. The valley fold portions 143 extend along the extension direction DE of the tab body portion 141. The mountain fold portions 144 extend along the extension direction DE.

As described above, the valley fold portions 143 and the mountain fold portions 144 extend along the extension direction DE, and thereby, the heat release portion 142 is relatively small in an orthogonal direction DX (the winding direction DR in the embodiment) that is orthogonal to the extension direction DE. Furthermore, the whole of the tab portion 140 is small in the above orthogonal direction DX, and the tab body portion 141 is easily connected to the first electrically conductive layer 120.

Further, in the embodiment, the tab body portion 141 has not been folded or has been folded a number of times smaller than the number of times of folding of the heat release portion 142.

With the above configuration, the tab body portion 141 includes many relatively flat portions, and therefore, the tab body portion 141 is easily joined to another electrically conductive member.

### Embodiment 2

Next, a first current collector and a battery according to Embodiment 2 of the present disclosure will be described. Descriptions about the same configurations and effects as those in Embodiment 1 are not repeated in some cases.

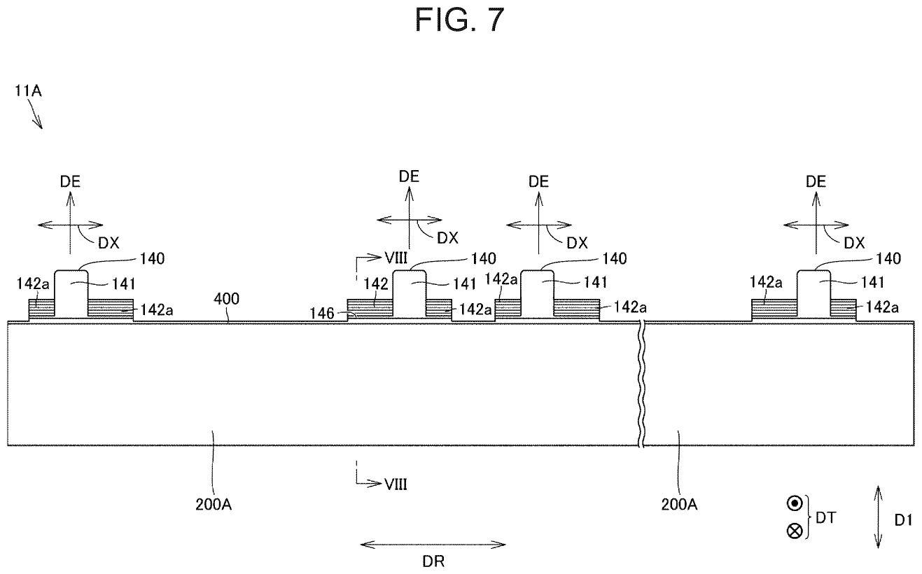

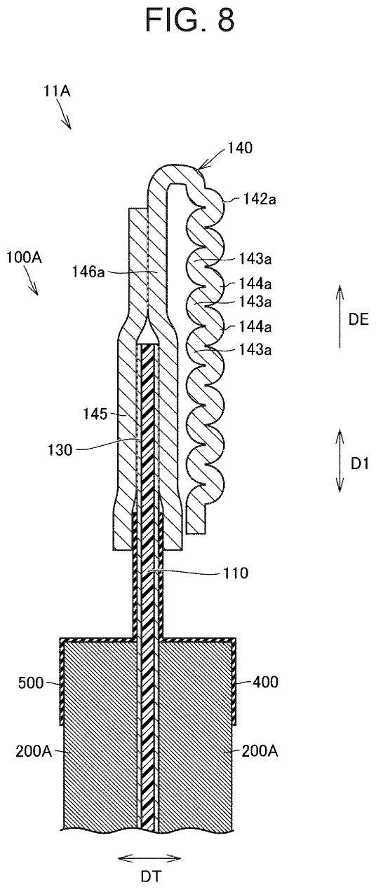

FIG. 7 is a developed view of a first electrode in Embodiment 2. FIG. 8 is a partial sectional view of the first electrode as viewed in a direction of arrow line VIII-VIII in FIG. 7.

As shown in FIG. 7 and FIG. 8, in Embodiment 2, a plurality of valley fold portions 143a extends along the orthogonal direction DX that is orthogonal to the extension direction DE of the tab body portion 141. A plurality of mountain fold portions 144a extends along the orthogonal direction DX.

As described above, the valley fold portions 143a and the mountain fold portions 144a extend along the orthogonal direction DX, and thereby, a heat release portion 142a can be formed by compressing a relatively long film-formed member in the extension direction DE. Further, the tab body portion 141 extends from the first electrically conductive layer 120, and thereby, the tab body portion 141 also is a member that is relatively long in the extension direction DE. Consequently, in the film-formed member constituting the tab portion 140, the variation in length in the extension direction DE is small over the whole in the orthogonal direction DX. Therefore, the film-formed member constituting the tab portion 140 is easily cut out of an original fabric film, so that it is possible to provide the first current collector 100A that is easily produced.

In the embodiment, the heat release portion 142a is not directly continuous with the tab body portion 141. The heat release portion 142a is not joined to the first electrically conductive layer 120 by ultrasonic welding.

In the embodiment, the tab portion 140 further includes a joining portion 146a. The joining portion 146a is continuous with the tab body portion 141 in the winding direction DR. The joining portion 146a is continuous with the heat release portion 142a, at an end portion of the joining portion 146a in the extension direction DE. The joining portion 146a and the heat release portion 142a are arrayed. The joining portion 146a is joined to the first electrically conductive layer 120 by ultrasonic joining.

In the above descriptions about the embodiments, configurations that can be combined may be mutually combined.

The embodiments disclosed herein should be considered in all respects as illustrative and not restrictive. The scope of the present disclosure is defined by the claims rather than the foregoing description, and is intended to include all changes that fall within the meaning and the scope equivalent to the claims.

What is claimed is:

1. A current collector comprising:
a support layer;
an electrically conductive layer; and
a tab portion, wherein:
the support layer is composed of a resin composition having electric insulation;
the electrically conductive layer is laminated on the support layer;
the tab portion is constituted by a film-formed member;
the tab portion includes a tab body portion and a heat release portion;
the tab body portion is connected with the electrically conductive layer;
the tab body portion is configured to be able to be joined to another electrically conductive member such that electric conduction with the other electrically conductive member is established; and
the heat release portion has been folded multiple times.

2. The current collector according to claim 1, wherein:
the tab body portion extends so as to be away from the electrically conductive layer;
the heat release portion includes a plurality of valley fold portions and a plurality of mountain fold portions;
the valley fold portions and the mountain fold portions are alternately arrayed;
the valley fold portions protrude to an electrically conductive layer side;
the mountain fold portions protrude to a side opposite to the electrically conductive layer side;
the valley fold portions extend along an extension direction of the tab body portion; and
the mountain fold portions extend along the extension direction.

3. The current collector according to claim 1, wherein:
the tab body portion extends so as to be away from the electrically conductive layer;
the heat release portion includes a plurality of valley fold portions and a plurality of mountain fold portions;
the valley fold portions and the mountain fold portions are alternately arrayed;
the valley fold portions protrude to an electrically conductive layer side;
the mountain fold portions protrude to a side opposite to the electrically conductive layer side;
the valley fold portions extend along an orthogonal direction that is orthogonal to an extension direction of the tab body portion; and
the mountain fold portions extend along the orthogonal direction.

4. The current collector according to claim 2, wherein the tab body portion has not been folded or has been folded a number of times smaller than the number of times of folding of the heat release portion.

5. A battery comprising:
an electrode body; and
an external terminal, wherein:
the electrode body includes a first electrode, a second electrode, and a separator;
the first electrode includes a current collector and an active material layer;
the current collector includes a support layer, an electrically conductive layer, and a tab portion;
the support layer is composed of a resin composition having electric insulation;
the electrically conductive layer is laminated on the support layer;
the tab portion is constituted by a film-formed member;
the tab portion includes a tab body portion and a heat release portion;
the tab body portion is connected with the electrically conductive layer;
the tab body portion is configured to be able to be joined to another electrically conductive member such that electric conduction with the other electrically conductive member is established;
the heat release portion has been folded multiple times;
the active material layer is laminated on the electrically conductive layer;
the separator is laminated on the active material layer;
the second electrode is laminated on the active material layer through the separator; and
the external terminal is electrically connected with the tab body portion.
